(19) United States
(12) Patent Application Publication
(10) Pub. No.: US 2026/0357879 A1
(43) Pub. Date: Nov. 12, 2026

(54) GEARING ARRANGEMENT, LONGITUDINAL ADJUSTMENT DEVICE, AND VEHICLE SEAT

(71) Applicant: Adient US LLC, Plymouth, MI (US)

(72) Inventor: Karl UTZINGER, Weselberg (DE)

(73) Assignee: Adient US LLC, Plymouth, MI (US)

(21) Appl. No.: 19/670,242

(22) Filed: May 7, 2026

(30) Foreign Application Priority Data
May 9, 2025 (DE) DE102025117883.6

(51) Int. Cl. F16H 25/20; B60N 2/06

(52) U.S. Cl. CPC F16H 25/2003; B60N 2/067

(57) ABSTRACT

A gearing arrangement for a spindle drive having a spindle, where the gearing arrangement may have a housing and a gearing mechanism. The gearing mechanism may have a plurality of gearwheels which may be coupled to one another in terms of movement. An eccentric unit is arranged between the housing and a gearwheel, which is in the form of an output wheel, and between the housing and the spindle. Use of the gearing arrangement with the spindle drive, a longitudinal adjustment device, and/or to a vehicle seat is also provided.

### FIELD

The invention relates to a gearing arrangement for a spindle drive, to a spindle drive, to a longitudinal adjustment device having a spindle drive, and to a vehicle seat.

### BACKGROUND

Longitudinal adjustment devices for vehicle seats are generally known, for example from DE 10 2021 214 875 A1 or CN 221 547 700 U. Longitudinal adjustment devices having large movement ranges are also known, for example in a minibus or the like. Longitudinal adjustment devices having large movement ranges usually have a long spindle. Particularly in poor road conditions, pronounced noises, so-called clicking noises, may occur during driving. The reason for this is that the spindle and the movable rail of the longitudinal adjustment device move relative to each other due to accelerations being carried out. This is caused by play between intermeshing and play-affected threads, which permits very small movements. This play causes a constantly changing metal on metal contact in the thread flanks between the threads, and thus the noises.

The invention is based on the problem of improving a gearing arrangement of the type mentioned at the beginning, in particular of providing a low-noise gearing arrangement. The invention is furthermore based on the problem of providing a spindle drive having an improved gearing arrangement, a corresponding longitudinal adjustment device, and a corresponding vehicle seat.

### SUMMARY

The first-mentioned problem is solved according to the invention by a gearing arrangement having the features of claim 1. The second-mentioned problem is solved according to the invention by a spindle drive having the features of claim 9. The third-mentioned problem is solved according to the invention by a longitudinal adjustment device having the features of claim 10. The fourth-mentioned problem is solved according to the invention by a vehicle seat having the features of claim 11.

The gearing arrangement according to the invention for a spindle drive having a spindle comprises a housing and a gearing mechanism, which has a plurality of gearwheels (also called toothed wheels) which are coupled to one another in terms of movement, wherein an eccentric unit is arranged between the housing and a gearwheel, which is in the form of an output wheel, and between the housing and the spindle.

Since the eccentric unit is arranged between the housing and the output wheel and between the housing and the spindle, a very stable and in particular play-free mounting of the output wheel and the spindle is made possible, since the eccentric unit compensates for possible play.

Advantageous refinements, which can be used individually or in combination with one another, are the subject matter of the dependent claims.

In particular, the eccentric unit can be configured such that the gearwheel or toothed wheel, which is in the form of an output wheel, is mounted in an axially movable, in particular longitudinally movable, manner.

Additionally or alternatively, the eccentric unit can be configured such that a spindle axis of the spindle can be mounted or is mounted eccentrically in the housing. Such an eccentric mounting of the axis of the spindle (eccentricity of the spindle axis) in the housing ensures that no play is produced in the thread between the output wheel and the spindle, so that changing metal on metal contacts are at least reduced or even avoided. The spindle is designed in particular as a fixed and non-rotating spindle. For example, for this purpose, the spindle may be fixedly mounted via spindle bearings.

For example, the eccentric unit can be configured to move the spindle relative to the output wheel in such a way that said spindle and thus the output wheel and the spindle are coupled to each other without play. In particular, the eccentric unit is configured to press the spindle in the housing in at least one direction, in particular downward or upward. For example, the spindle in the housing is pressed in the direction of the output wheel.

In addition, the eccentric unit can be configured to move the spindle relative to the output wheel in such a way that thread flanks of the output wheel and thread flanks of the spindle are coupled to each other without play. This means that the eccentric unit presses the spindle relative to the output wheel in such a way that there is no longer any play between the thread flanks of the spindle and the output wheel.

For example, the eccentric unit can have at least one eccentric which comprises a cam part which is configured to mount the spindle in the housing in such a way that the spindle axis lies eccentrically in the housing. Alternatively, the eccentric unit can comprise a plurality of eccentrics, in particular two eccentrics, for example at each bearing end of the output wheel.

The cam part can have, for example, a cam circumference which has an outer cam formation rising in the direction of the housing. In the direction of the spindle, the cam part has a corresponding inner circumference, in particular a circular inner circumference.

Furthermore, the eccentric can be mounted, for example, in a spring-preloaded manner in the housing. If a plurality of eccentrics are provided, a spring can be provided for each eccentric, for example. The respective spring can be coupled on the one hand to the eccentric and on the other hand to the housing. In addition, the spring can be mounted in the housing on a hollow-cylindrical housing section.

A spindle drive according to the invention comprises a spindle motor and a spindle, with the previously described gearing arrangement being connected or arranged between them. A longitudinal adjustment device according to the invention for a vehicle seat comprises such a spindle drive. A vehicle seat according to the invention comprises such a longitudinal adjustment device.

In summary and in other words, the invention makes it possible for the spindle to be pressed downward relative to the gearwheel, so that no play is produced between the thread flanks of the spindle and the gearwheel.

### DESCRIPTION OF THE FIGURES

In the following text, the invention is explained in greater detail using advantageous exemplary embodiments illustrated in the figures. However, the invention is not limited to these exemplary embodiments. In the figures:

FIG. 1: shows a schematic illustration of a vehicle seat with a longitudinal adjustment device,

FIG. 2: shows a side view of a longitudinal adjustment device according to the prior art,

FIG. 3: shows a top view of the longitudinal adjustment device according to FIG. 2 (prior art),

FIG. 4: shows a sectional illustration of the longitudinal adjustment device in the region of a gearing arrangement and of a spindle drive according to FIG. 2 (prior art),

FIG. 5: shows a further sectional illustration in the region of thread flanks of the output wheel and the spindle according to the prior art,

FIG. 6: shows an exploded illustration of an example of a gearing arrangement according to the invention,

FIG. 7: shows a sectional illustration of an example of the gearing arrangement according to the invention,

FIG. 8: shows a view from the front of an example of the gearing arrangement according to the invention,

FIG. 9: shows a side view of the example of the gearing arrangement according to the invention,

FIG. 10: shows a sectional illustration of the example of the gearing arrangement according to the invention according to FIG. 9, and

FIG. 11: shows a further view from the front of the example of the gearing arrangement according to the invention.

### DETAILED DESCRIPTION

Parts which correspond to each other are provided with the same reference signs in all of the figures.

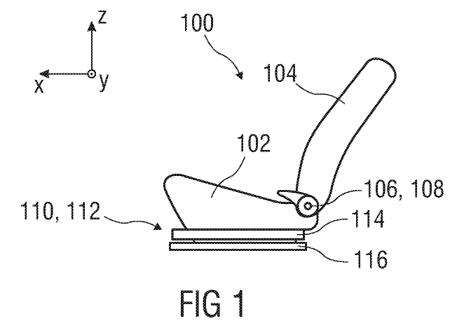

A vehicle seat 100 schematically illustrated in FIG. 1 in respect of the prior art is described below using three spatial directions which run perpendicularly with respect to each other. A longitudinal direction x extends, in a vehicle seat 100 installed in the vehicle, largely horizontally and preferably parallel to a vehicle longitudinal direction, which corresponds to the normal direction of travel of the vehicle. A transverse direction y running perpendicularly with respect to the longitudinal direction x is also oriented horizontally in the vehicle and runs parallel to a vehicle transverse direction. A vertical direction z runs perpendicularly with respect to the longitudinal direction x and perpendicularly with respect to the transverse direction y. In a vehicle seat 100 installed in the vehicle, the vertical direction z preferably runs parallel to a vehicle vertical axis.

The position information and direction information used, for example front, rear, top and bottom, refer to a viewing direction of an occupant seated on the vehicle seat 100 in the normal seating position, wherein the vehicle seat 100 is installed in the vehicle, in a use position suitable for passenger transport with upright backrest 104 and as usual is oriented in the direction of travel. However, the vehicle seat 100 can also be installed or moved in a different orientation, for example transversely with respect to the direction of travel. Unless otherwise described, the vehicle seat 100 is constructed mirror-symmetrically with respect to a plane running perpendicularly with respect to the transverse direction y.

The backrest 104 can be arranged pivotably on a seat part 102 of the vehicle seat 100. To this end, the vehicle seat 100 can optionally comprise a fitting 106, in particular a adjustment fitting, rotating fitting, latching fitting or tumbling fitting.

The position information and direction information used, for example radial, axial and in the circumferential direction, refer to a rotational axis 108 of the fitting 106. Radial means perpendicular with respect to the rotational axis 108. Axial means in the direction of or parallel to the rotational axis 108.

The vehicle seat 100 can optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to as upper rail 114 in the following description. This upper rail 114 (also called running rail or carriage) is assigned to the vehicle seat 100 and is configured to support this vehicle seat 100. The second rail element 116 is referred to as lower rail 116 in the following text. The lower rail 116 is connected fixedly and, for example, to the floor of a vehicle.

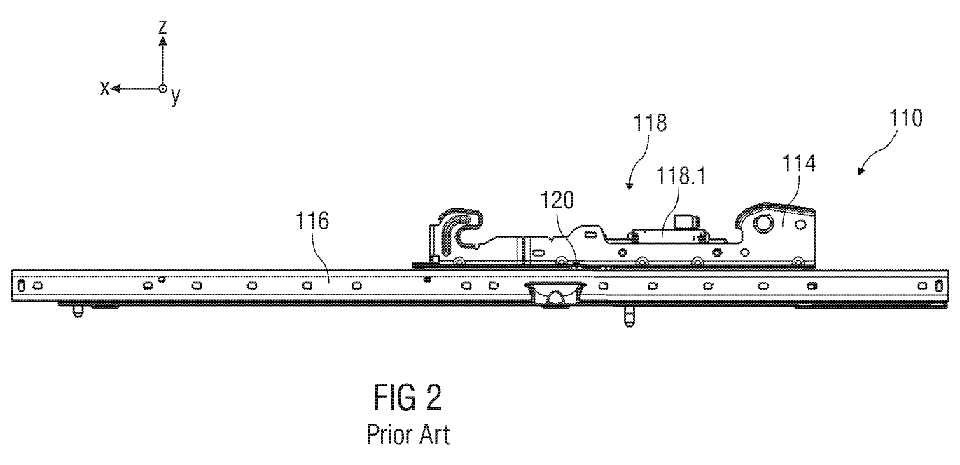

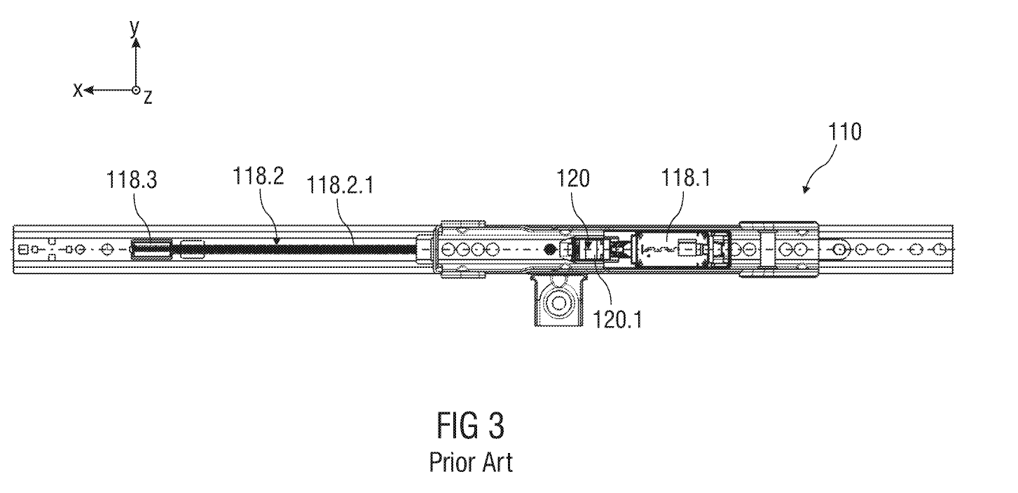

FIG. 2 shows a side view of a longitudinal adjustment device 110 according to the prior art. FIG. 3 shows a top view of the longitudinal adjustment device 110 according to FIG. 2 (prior art).

For the longitudinal adjustment, the longitudinal adjustment device 110 comprises, in addition to the upper rail 114, which is arranged in a longitudinally adjustable manner on the lower rail 116, a spindle drive 118 and a gearing arrangement 120.

The spindle drive 118 comprises a spindle motor 118.1 (also referred to as motor for short), in particular an electric motor, and a spindle 118.2 (illustrated in FIG. 3) and the gearing arrangement 120 connected between them for transmitting the drive movement of the spindle motor 118.1 via the gearing arrangement 120 to the upper rail 114 and for converting a rotational movement of the spindle motor 118.1 into a linear adjustment movement of the upper rail 114.

The spindle 118.2 is fastened to the lower rail 116. For example, corresponding spindle bearings 118.3 (illustrated in FIG. 3) are fastened to the lower rail 116. The spindle 118.2 is held on or at the spindle bearings 118.3. The spindle 118.2 is rigid. That is to say that the spindle 118.2 is of non-rotating design. The spindle 118.2 has an external thread 118.2.1.

The gearing arrangement 120 has a housing 120.1 (illustrated in FIG. 3) which is fastened to the upper rail 114, in particular is held in a form-fitting and/or force-fitting manner.

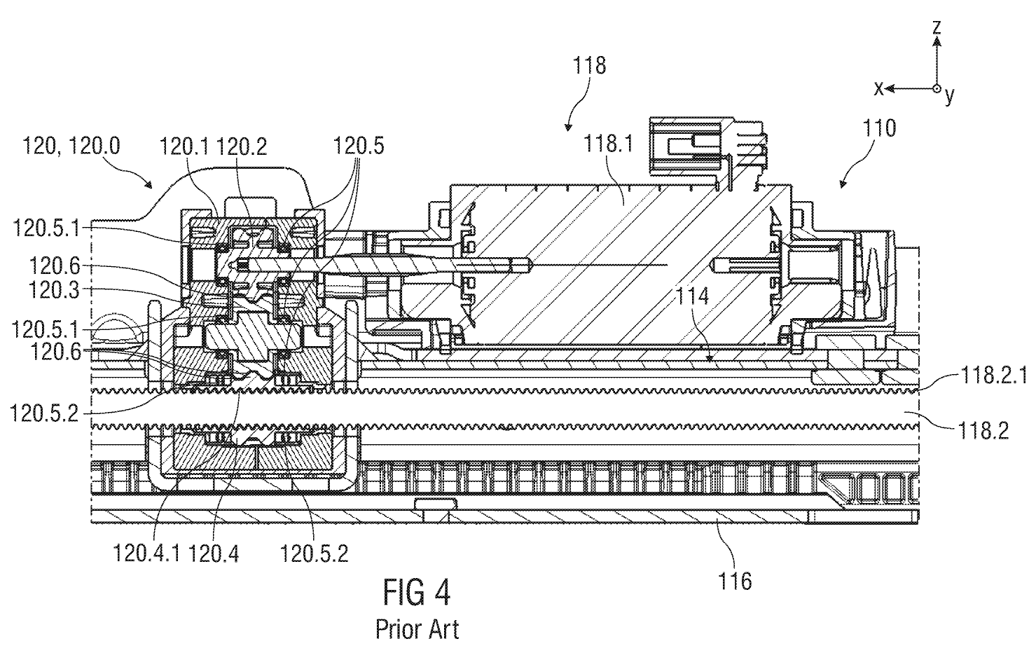

FIG. 4 shows a sectional illustration of the longitudinal adjustment device 110 in the region of the gearing arrangement 120 and of the spindle drive 118 according to FIG. 2 (prior art).

The gearing arrangement 120 comprises a gearing mechanism 120.0, which is in the form, for example, of a gearwheel gearing mechanism. The gearing arrangement 120 comprises the housing 120.1 and a number of gearwheels 120.2 to 120.4 (also referred to as toothed wheels).

For example, three gearwheels 120.2 to 120.4 are arranged in the interior of the housing 120.1 (also called the gearing housing).

A first gearwheel 120.2 is coupled to the spindle motor 118.1. The first gearwheel 120.2 is in operative engagement with a second gearwheel 120.3. The second gearwheel 120.3 is in operative engagement with a third gearwheel 120.4. The gearwheels 120.2 to 120.4 are in operative engagement with one another and coupled in terms of movement via associated external toothings 120.6. In particular, the three gearwheels 120.2 to 120.4 are rotatably mounted in the housing 120.1 by rotary bearings 120.5, in particular ball bearings 120.5.1 and/or bearing bushings 120.5.2.

The third gearwheel 120.4, which is in the form in particular of an output wheel, has, in addition to the external toothing 120.6, an internal thread 120.4.1 which is designed corresponding to the external thread 118.2.1 of the spindle 118.2. The gearwheel 120.4 is connected to the spindle 118.2.

When the gearing mechanism 120.0 is driven by the spindle motor 118.1, the upper rail 114 moves forward or backward relative to the lower rail 116 in the longitudinal direction x. This function is used to move the vehicle seat 100 (illustrated in FIG. 1) forward or backward.

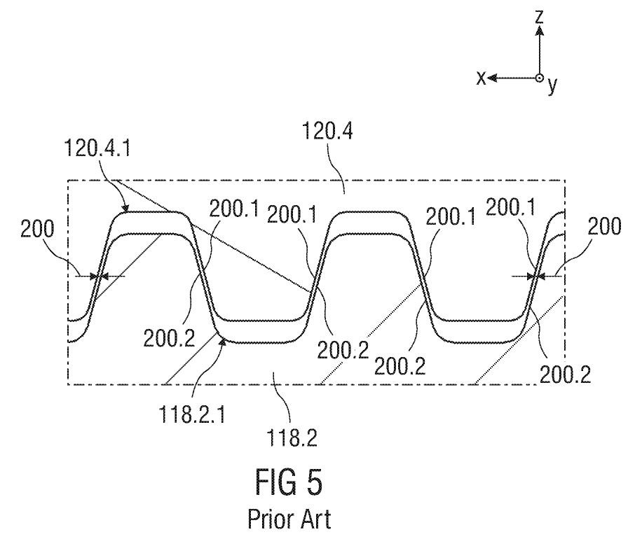

FIG. 5 shows a further sectional illustration in the region of thread flanks 200.1, 200.2 of the third gearwheel 120.4, which is in the form of an output wheel, and of the spindle 118.2 according to the prior art.

In this case, play 200 can be formed between the intermeshing and play-affected threads, the internal thread 120.4.1 and the external thread 118.2.1 of the spindle 118.2, which play permits relative movements. This play 200 can produce a constantly changing metal on metal contact in the thread flanks 200.1, 200.2 between the internal thread 120.4.1 and the external thread 118.2.1, and thus noises resulting therefrom.

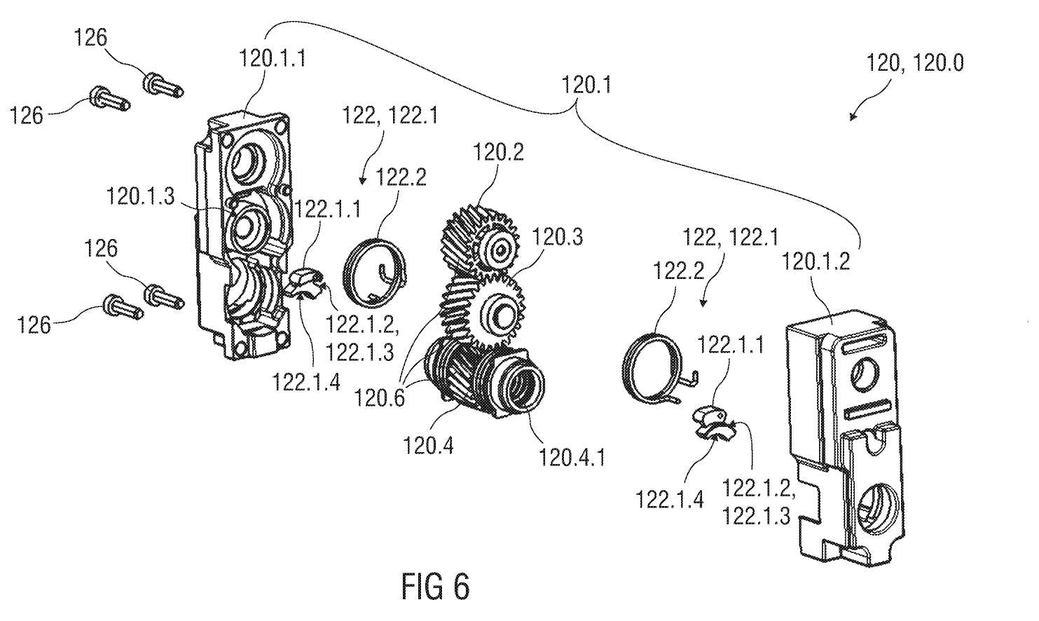

FIG. 6 shows an exploded illustration of an example of a gearing arrangement 120 according to the invention. The latter is designed substantially analogously to the gearing arrangement 120 according to FIGS. 2-5, which has already been described above. The gearing arrangement 120 according to the invention according to FIGS. 6-11 differs in that an eccentric unit 122 is additionally provided.

The gearing arrangement 120 comprises the housing 120.1 and the gearing mechanism 120.0, which has a plurality of gearwheels 120.2 to 120.4 which are coupled to one another in terms of movement, wherein an eccentric unit 122 is arranged between the housing 120.1 and the third gearwheel 120.4, which is in the form of an output wheel, and between the housing 120.1 and the spindle 118.2.

For example, the eccentric unit 122 may have just one eccentric 122.1 or, as illustrated by way of example, two eccentrics 122.1 or a plurality of eccentrics 122.1. In the case of two eccentrics 122.1, these can be provided, for example, at each bearing end of the third gearwheel 120.4, which is in the form of an output wheel.

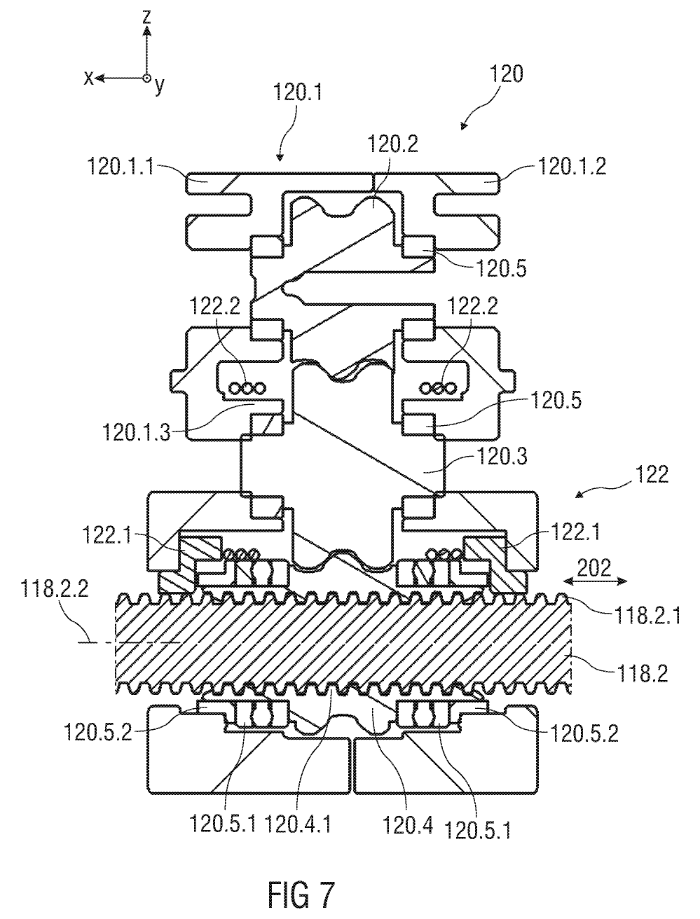

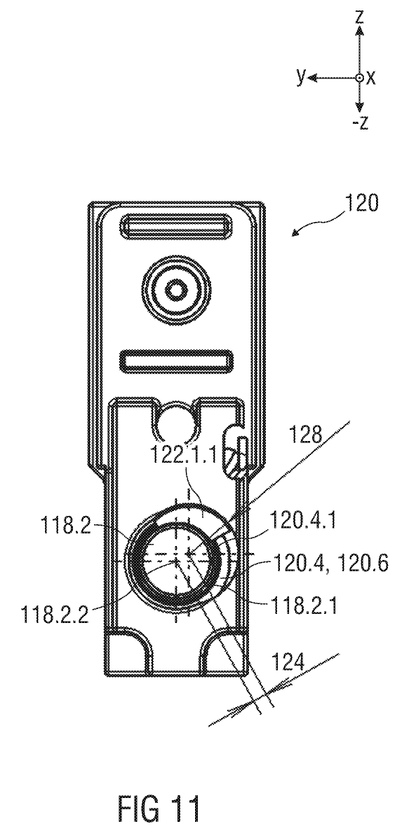

The respective eccentric 122.1 can comprise a cam part 122.1.1 which is configured to mount the spindle 118.2 (illustrated in FIG. 7) in the housing 120.1 in such a way that a spindle axis 118.2.2 (illustrated in FIGS. 7 or 11) lies eccentrically in the housing 120.1.

The respective cam part 122.1.1 can have, for example, a cam circumference 122.1.2 which has an outer cam formation 122.1.3 rising in the direction of the housing 120.1. In the direction of the spindle 118.2, the cam part 122.1.1 can have a corresponding inner circumference 122.1.4, in particular a circular inner circumference 122.1.4.

Furthermore, the respective eccentric 122.1 can be mounted, for example, in a spring-preloaded manner in the housing 120.1. If a plurality of eccentrics 122.1 are provided, a spring 122.2 can be provided for each eccentric 122.1, for example. The respective spring 122.2 can be coupled on the one hand to the eccentric 122.1 and on the other hand to the housing 120.1. In addition, the spring 122.2 can be mounted in the housing 120.1 on a hollow-cylindrical housing section 120.1.3.

The housing 120.1 can be formed in multiple parts, in particular in two parts. The housing 120.1 can comprise a first housing part 120.1.1 and a second housing part 120.1.2. The two housing parts 120.1.1 and 120.1.1 canbe connected to each other in the assembled state. For this purpose, for example, corresponding connecting elements 126, in particular screws and internal threads or nuts, can be provided.

The cam parts 122.1.1 and associated springs 122.2 are installed in the two housing parts 120.1.1 and 120.1.2. These cam parts 122.1.1 have an eccentric mounting with respect to the spindle axis 118.2.2 of the spindle 118.2 with an eccentricity 124 (illustrated in FIG. 11). The cam parts 122.1.1 are loaded by the springs 122.2.

FIG. 7 shows a sectional illustration of the example of the gearing arrangement 120 according to the invention.

The additional eccentric unit 122 can in particular be configured such that the third gearwheel 120.4, which is in the form of an output wheel, is mounted in an axially movable manner. In this case, the third gearwheel 120.4 can be mounted in an axially movable manner in the housing 120.1 according to arrow 202, in particular in an axially movable manner between the housing parts 120.1.1 and 120.1.2, just by one eccentric 122.1 (one-sided arrangement) or by two eccentrics 122.1 (two-sided arrangement/arrangement on both sides). For this purpose, the associated spring 122.2, which is arranged on the hollow-cylindrical housing section 120.1.3, is provided for each eccentric 122.1.

The third gearwheel 120.4 can be rotatably mounted in the housing 120.1, for example, by ball bearings 120.5.1 and by bearing bushings 120.5.2.

The first gearwheel 120.2 and the second gearwheel 120.3 are rotatably mounted in the housing 120.1 via associated rotary bearings 120.5.

As a result of the eccentric unit 122, the internal thread 120.4.1 of the output wheel is in play-free engagement with the external thread 118.2.1 of the spindle 118.2.

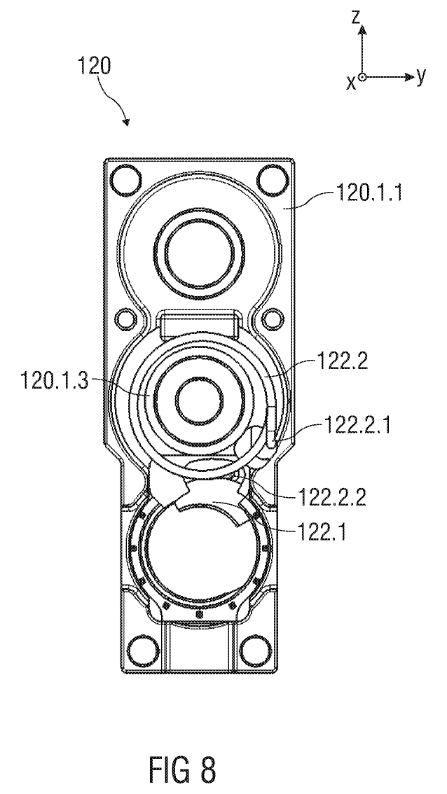

FIG. 8 shows a view of an inner side of one of the housing parts 120.1.1 of the gearing arrangement 120 according to the invention and without gearwheels 120.2 to 120.4. The spring 122.2 is mounted in the housing part 120.1.1 on the housing section 120.1.3. A first spring end 122.2.1 is coupled to the housing part 120.1.1. One of the eccentrics 122.1 is mounted in the housing part 120.1.1. A second spring end 122.2.2 is coupled to the eccentric 122.1.

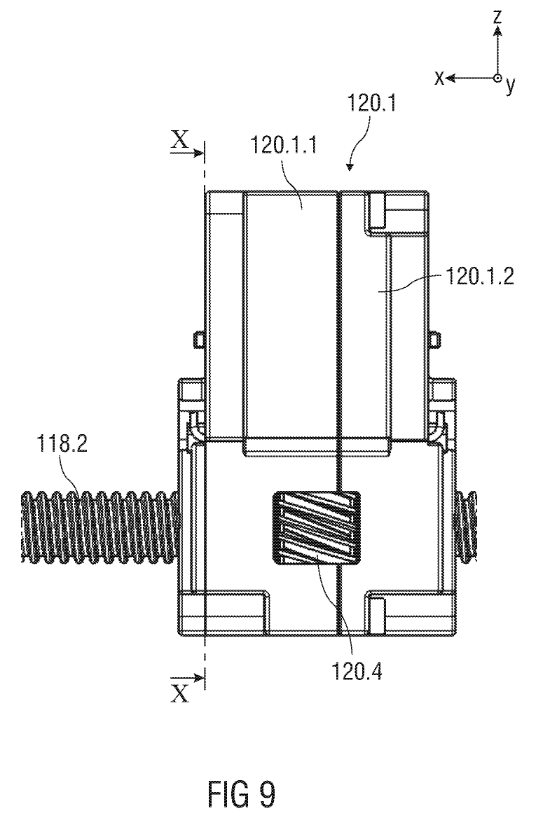

FIG. 9 shows a side view of the housing 120.1 in the assembled state of the two housing parts 120.1.1 and 120.1.2. The spindle 118.2 is rigidly arranged in the third gearwheel 120.4, such that a rotational movement of the third gearwheel 120.4 is converted into a longitudinal movement on the spindle 118.2.

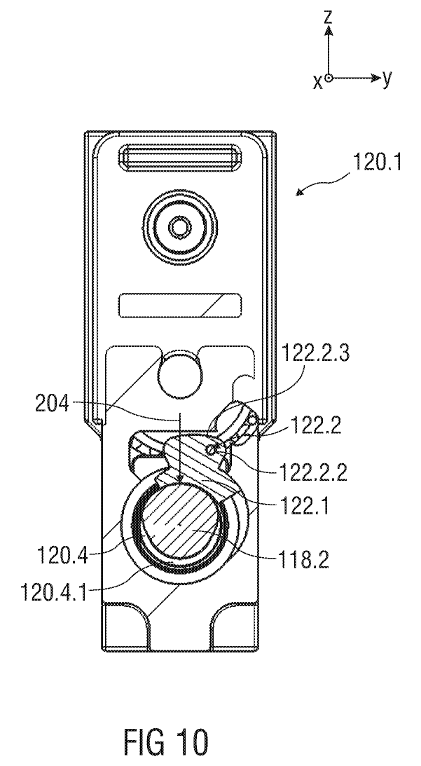

FIG. 10 shows a sectional illustration of the example in the region of the housing 120.1 according to FIG. 9.

The eccentric 122.1 is arranged between the housing 120.1 and the spindle 118.2 and, owing to its cam shape, presses the latter in the direction of the internal thread 120.4.1 of the third gearwheel 120.4, according to arrow 204.

The second spring end 122.2.2 is coupled to the eccentric 122.1. As a result, a corresponding spring force 122.2.3 is exerted on the eccentric 122.1.

FIG. 11 shows a view from the front of the gearing arrangement 120 according to the invention.

The cam part 122.1.1 has an eccentric bearing with respect to the spindle axis 118.2.2 of the spindle 118.2 with an eccentricity 124.

In this case, the eccentric unit 122 can generally be configured such that the spindle axis 118.2.2 can be or is mounted eccentrically in the housing 120.1. Such an eccentric mounting of the spindle axis 118.2.2 (= eccentricity 124 of the spindle axis 118.2.2) in the housing 120.1 ensures that no play 200 according to the prior art (illustrated in FIG. 5) is produced between the internal thread 120.4.1 and the external thread 118.2.1, so that alternating metal on metal contacts are at least reduced or avoided.

For example, the eccentric unit 122 can be configured to move the spindle 118.2 relative to the output wheel (= third gearwheel 120.4) in such a way that they are coupled to each other without play. In particular, the eccentric unit 122 is configured to press the spindle 118.2 in the housing in at least one direction, in particular downward or upward, against the internal thread 120.4.1 of the third gearwheel 120.4.

In addition, the eccentric unit 122 can be configured to move the spindle 118.2 relative to the third gearwheel 120.4 in such a way that the thread flanks 200.1, 200.2 (illustrated in FIG. 5) of the third gearwheel 120.4 and of the spindle 118.2 are coupled to each other without play (without play 200). This means that the eccentric unit 122 presses the spindle 118.2 relative to the output wheel in such a way that there is no longer any play 200 between the thread flanks 200.1, 200.2.

The cam parts 122.1.1 are additionally loaded by the springs 122.2. The respective spring-loaded cam part 122.1.1 presses the spindle 118.2 downward against the internal thread 120.4.1 in the third gearwheel 120.4 (-z direction). The resulting eccentricity 124 of the spindle axis 118.2.2 with respect to a radius 128 of a housing pocket is configured such that it has no self-locking effect. As a result, clamping of the spindle 118.2 in the clamped state can be avoided. When the upper rail 114 is adjusted, the cam parts 122.1.1 (also called cams) slide relative to the spindle 118.2 at the outer diameter thereof in the longitudinal direction x.

The eccentric unit 122 may also be configured such that only one cam part 122.1.1 and one spring 122.2 are provided. This means that only one eccentric 122.1 acting on one side is provided. The direction of the spring force 122.2.3 can also be implemented in directions other than in the direction shown in FIG. 10. For example, the spring force 122.2.3 can also act in the vertical direction z (= +z direction), in the transverse direction y (in the +y or -y direction) or in any desired direction between the transverse direction y and the vertical direction z and can press the cam part 122.1.1 accordingly in a direction-related manner.

### LIST OF REFERENCE SIGNS

100 Vehicle seat
102 Seat part
104 Backrest
106 Fitting
108 Rotational axis
110 Longitudinal adjustment device
112 Rail arrangement
114 First rail element (upper rail)
116 Second rail element (lower rail)
118 Spindle drive
118.1 Spindle motor
118.2 Spindle
118.2.1 External thread
118.2.2 Spindle axis
118.3 Spindle bearing 1
20 Gearing arrangement
120.0 Gearing mechanism
120.1 Housing
120.1.1 First housing part
120.1.2 Second housing part
120.1.3 Housing section
120.2 First gearwheel, gearwheel
120.3 Second gearwheel, gearwheel
120.4 Third gearwheel, gearwheel
120.4.1 Internal thread
120.5 Rotary bearing
120.5.1 Ball bearing
120.5.2 Bearing bushings
120.6 External toothing
122 Eccentric unit
122.1 Eccentric
122.1.1 Cam part
122.1.2 Cam circumference
122.1.3 Outer cam formation
122.1.4 Inner circumference
122.2 Spring
122.2.1 First spring end
122.2.2 Second spring end
122.2.3 Spring force
124 Eccentricity
126 Connecting element
128 Radius
200 Play
200.1, 200.2 Thread flanks
202, 204 Arrow
x Longitudinal direction
y Transverse direction
z Vertical direction

What is claimed is:

1. A gearing arrangement for a spindle drive having a spindle, wherein the gearing arrangement comprises:
a housing and
a gearing mechanism, which has a plurality of gearwheels which are coupled to one another in terms of movement,
wherein an eccentric unit is arranged between the housing and a gearwheel, which is in the form of an output wheel, and between the housing and the spindle, and
wherein the eccentric unit is configured such that the gearwheel is mounted in an axially movable manner in the housing.

2. The gearing arrangement as claimed in claim 1,
wherein the gearwheel and the spindle are coupled to each other without play.

3. The gearing arrangement as claimed in claim 1,
wherein the eccentric unit is configured such that a spindle axis of the spindle is mounted or is mounted eccentrically in the housing.

4. The gearing arrangement as claimed in claim 1,
wherein the eccentric unit is configured to move the spindle relative to the gearwheel in such a way that thread flanks of the gearwheel and of the spindle are coupled to each other without play.

5. The gearing arrangement as claimed in claim 3,
wherein the eccentric unit has at least one eccentric which comprises a cam part which is configured to mount the spindle in the housing in such a way that the spindle axis lies eccentrically in the housing.

6. The gearing arrangement as claimed in claim 5,
wherein the cam part has a cam circumference which has an outer cam formation which rises in the direction of the housing.

7. The gearing arrangement as claimed in claim 5,
wherein the eccentric is mounted in a spring-preloaded manner in the housing.

8. The gearing arrangement as claimed in claim 5,
wherein a spring is provided for each eccentric, said spring being coupled on the one hand to the eccentric and on the other hand to the housing.

9. The spindle drive having the spindle motor and the spindle and having the gearing arrangement as claimed in claim 1 connected between them.

10. A longitudinal adjustment device for a vehicle seat, comprising the spindle drive as claimed in claim 9.

11. The vehicle seat having the longitudinal adjustment device as claimed in claim 10.
